(19) United States
(12) Patent Application Publication
(10) Pub. No.: US 2020/0064678 A1
(43) Pub. Date: Feb. 27, 2020

(54) DISPLAY DEVICE

(71) Applicant: SHARP KABUSHIKI KAISHA, Sakai City, Osaka (JP)

(72) Inventor: HIROAKI ISOBE, Sakai City, Osaka (JP)

(21) Appl. No.: 16/611,820

(22) PCT Filed: May 15, 2018
(86) PCT No.: PCT/JP2018/018671

§ 371 Date: Nov. 7, 2019

(30) Foreign Application Priority Data
May 22, 2017 (JP) 2017-100583

(51) Int. Cl. G02F 1/1333

(52) U.S. Cl. CPC G02F 1/133308; G02F 2202/28; G02F 2001/13332; G02F 2001/133314; G02F 2001/133317

(57) ABSTRACT

A display device includes: a display panel for displaying an image; a holding member for holding the display panel; and a double-sided tape for fixing the display panel relative to the holding member, which has a longitudinal tape body part adhered to both the holding member and the display panel, and a tape end part provided to one end part in the longitudinal direction of the tape body part and arranged more outside than an outer periphery end part of the display panel. A surface of at least a section of the tape end part on the holding member side is arranged oppositely at an interval with the holding member.

### TECHNICAL FIELD

The present invention relates to a display device.

### BACKGROUND ART

A display device having a structure in which a display panel is adhered to a holding member (frame) with a double-sided tape has been known (the following Patent Document 1). Furthermore, in the Patent Document 1, it is described that when a display device is inspected after assemble of the display device and found that the display panel is not rightly arranged or an extraneous substance is found between a back-light and the display panel, a double-sided tape is peeled to remove the display panel from the holding member, after cleaning the display panel, once more, the display panel is fixed with the double-sided tape.

### RELATED ART DOCUMENT

### Patent Documents

Patent Document 1: Japanese Unexamined Patent Application Publication NO. 2008-203444

### Problem to be Solved by the Invention

In the above structure, when the display panel is removed from the holding member, it is necessary to peel the double-sided tape with the display panel and the holding member separated from each other, there is a care of a case where an external force is applied on the display panel.

### DISCLOSURE OF THE PRESENT INVENTION

The present invention was completed based on a situation such as described above, and it is intended to provide a display device capable of removing the display panel from the holding member while suppressing a situation where an external force acts on the display panel.

### Means for Solving the Problem

In order to solve the above problem, a display device of the present invention includes: a display panel for displaying an image; a holding member for holding the display panel; and a double-sided tape for fixing the display panel to the holding member, which has a longitudinal tape body part adhered to both the holding member and the display panel and a tape end part provided to one end part in the longitudinal direction of the tape body part and arranged more outside than an outer periphery end part of the display panel, in which a surface on the holding member side in at least a part of the tape end part is arranged oppositely at an interval with the holding member. According to the above structure, an operator may draw out the tape body part from between the holding member and the display panel by grasping the tape end part with a tool and by drawing out. Thus, in comparison with a method of peeling the double-sided tape by separating the display panel and the holding member each other, a situation where the external force is applied on the display panel may be suppressed. Furthermore, a surface on the holding member side in at least a part of the tape end part is arranged oppositely at an interval with the holding member. Therefore, the tape end part may be readily peeled and grasped.

### Advantageous Effect of the Invention

According to the present invention, a display device capable of removing a display panel from a holding member while suppressing a case where the external force is applied on the display panel may be provided.

### BRIEF DESCRIPTION OF THE DRAWINGS

FIG. 1 is a perspective view showing a liquid crystal display device according to Embodiment 1 of the present invention.

FIG. 2 is a plan view showing the vicinity of a tape end part in a double-sided tape.

FIG. 3 is a cross-sectional view showing the liquid crystal display device (corresponding to a drawing obtained by cutting FIG. 2 with a III-III line.)

FIG. 4 is a cross-sectional view showing a liquid crystal display device according to Embodiment 2.

FIG. 5 is a cross-sectional view showing a liquid crystal display device according to Embodiment 3.

FIG. 6 is a cross-sectional view showing a liquid crystal display device according to Embodiment 4.

FIG. 7 is a cross-sectional view showing a liquid crystal display device according to Embodiment 5.

FIG. 8 is a cross-sectional view showing a liquid crystal display device according to Embodiment 6.

FIG. 9 is a cross-sectional view showing a liquid crystal display device according to Embodiment 7.

### BEST MODES FOR CARRYING OUT THE INVENTION

### First Embodiment

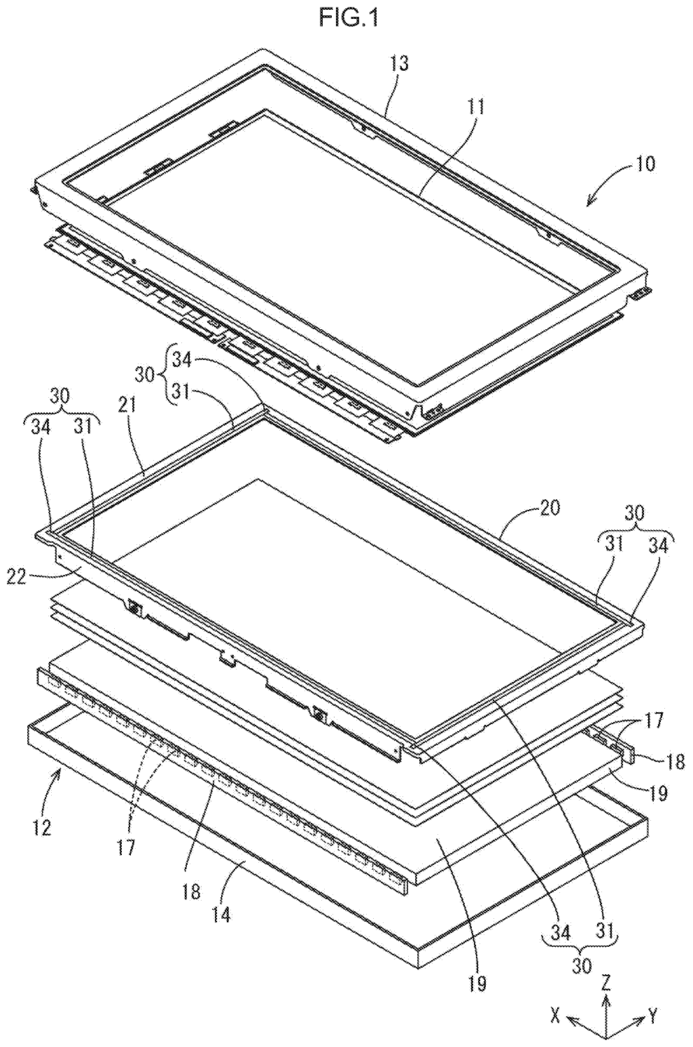

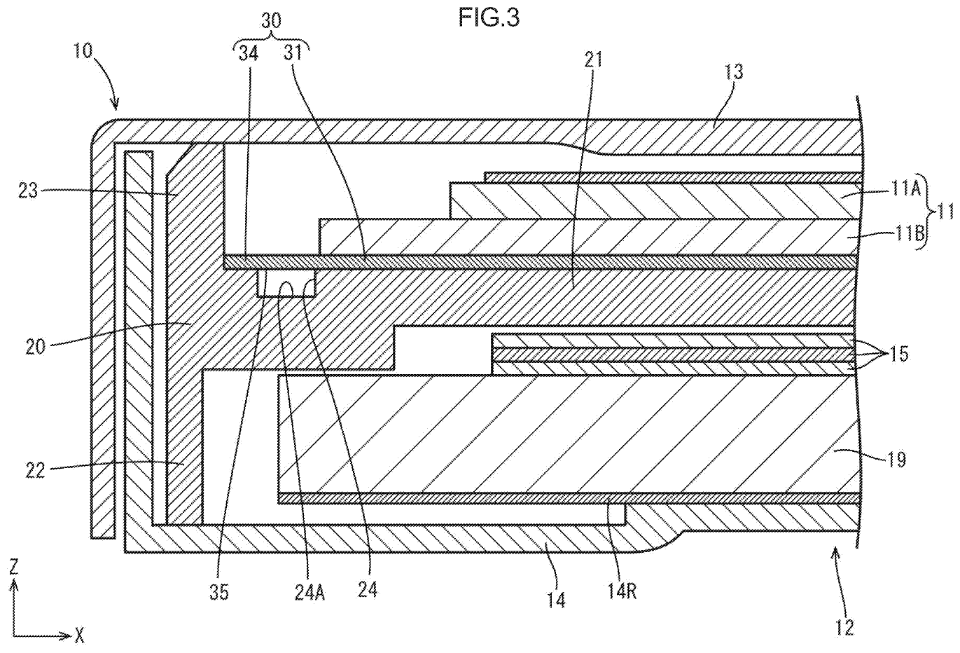

The first embodiment of the present invention will be described with reference to FIG. 1 to FIG. 3. In the present embodiment, as a display device, a liquid crystal display device 10 is illustrated. By the way, in a part of each of drawings, an X axis, a Y axis and a Z axis are shown, and each axis direction is drawn so as to be a direction shown in each of drawings. Furthermore, an upper side in FIG. 1 and FIG. 3 is a front side (a lower side is a back side). As shown in FIG. 1, the liquid crystal display device 10 according to the present embodiment forms a rectangular shape as a whole, is provided with a back light device 12 (back light unit) and a liquid crystal panel 11 (display panel) capable of displaying an image with a light emitted from the back light device 12, and these are integrally held by a frame-like bezel 13.

The liquid crystal panel 11 that includes a pair of substrates 11A and 11B (see FIG. 3) adhered with a predetermined gap separated and a liquid crystal (not shown in the drawing) encapsulated between both glass substrates 11A and 11B may be used. A front side substrate of the pair of substrates 11A, 11B is taken as a counter substrate 11A, and a back side substrate is taken as an array substrate 11B (active matrix substrate, element substrate). Both the counter substrate 11A and the array substrate 11B are formed by lamination of various kinds of films on an inner surface side of a glass substrate made of glass. The array substrate 11B includes a switching element (for example TFT) connected to mutually orthogonal source line and gate line, a pixel electrode connected to the switching element, and furthermore an orientation film. The counter substrate 11A includes a color filter in which each of colored parts of R (red color), G (green color), and B (blue color) is arranged in a predetermined array, a counter electrode, furthermore the orientation film. By the way, on the outside of each of the both substrates, a polarization plate (not shown in the drawing) is arranged. The liquid crystal panel 11 is arranged with a posture in which a normal direction of the plate surface coincides with a Z-axis direction.

The back light device 12 forms, as shown in FIG. 1, a rectangular shape in a plan view, that is, a so-called edge light type (side light type). As shown in FIG. 1, the back light device 12 includes a substantially box-type chassis 14 and a flame 20 opening on a front side, that is, a light-emitting side (liquid crystal panel 11 side). Furthermore, on a back side of a bottom plate of the chassis 14, substrates such as a control substrate or LED driving circuit board that are not shown are attached. Inside of the chassis 14, an LED substrate 18 on which an LED 17 (Light Emitting Diode) is mounted, and a light guide plate 19 are housed. In the back light device 12, on both end parts on a longitudinal side along an X-axis, an LED substrate 18 is arranged respectively, and a pair of LED substrates 18 are arranged in the form of sandwiching the light guide plate 19 from both sides of its short side direction (a Y axis direction). The LED 17 that is a light source is a so-called top-emitting type, and a plurality of the LEDs are arranged along a longitudinal direction (X-axis direction) of the light guide plate 19.

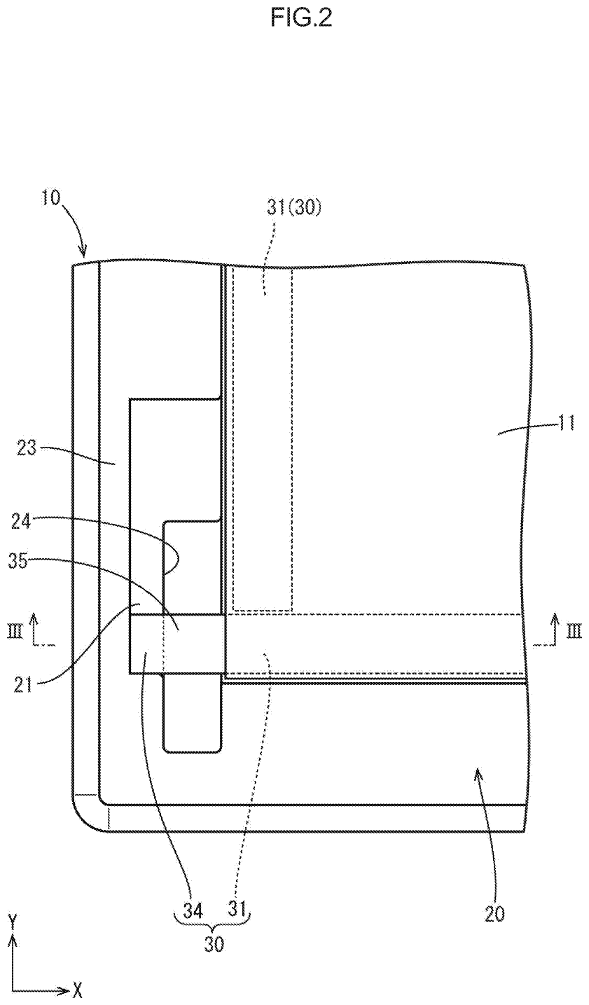

The light guide plate 19 is made of a synthetic resin material (for example, an acrylic resin such as PMMA) that has a refractive index sufficiently higher than that of air and substantial transparency (excellent transparency) and has a function of introducing light emitted from the LED 17 from an end surface on a long edge side, and, while making the light propagate inside thereof, rising up so as to direct on the liquid crystal panel 11 side (front side, an optical member 15 side described below) along the Z-axis direction and making exit from a plate surface. On a back side of the light guide plate 19, as shown in FIG. 2, a chassis side reflective sheet 14R is arranged. The chassis side reflective sheet 14R has a function of reflecting the light emitted on a back side of the light guide plate 19 to a front side to emit from the front side (light output side). An optical member 15 is interposed between the liquid crystal panel 11 and the light guide plate 19. The optical member 15 is formed by laminating a plurality of sheet-like members (three sheets in the present embodiment) appropriately selected from a diffusion sheet, a lens sheet, and a reflective polarization sheet, and has a function of transmitting light emitted from the light guide plate 19, and emitting light toward the liquid crystal panel 11 while imparting a predetermined optical action to the transmitted light.

The frame 20 (holding member) may be formed by injection molding, for example, a PC (polycarbonate) resin or an ABS (acrylonitrile butadiene styrene) resin. The frame 20 has, as shown in FIG. 1 and FIG. 3, a rectangular frame shape, and includes a frame part 21, a side frame part 22 projected toward the back side from an outer periphery part of the frame part 21 (peripheral four sides) and a side frame part 23 (omitted from showing in FIG. 1) respectively projected toward a front side from an outer periphery end part of the frame 21. The frame 20 and the bezel 13 are fixed to a side plate of the chassis 14 with a screw (not shown in the drawing). The frame part 21 covers the outer periphery edge part of the light guide plate 19 from the front side and has a shape of covering the outer periphery edge part of the liquid crystal panel 11 from the back side. On a front surface of the frame part 21, as shown in FIG. 3, the back surface of the liquid crystal panel 11 is fixed by adhering with a double-sided tape 30. Thus, the outer periphery edge part of the liquid crystal panel 11 is held by the frame 20.

The double-sided tape 30 includes, as shown in FIG. 3, a tape body part 31 adhered to both the frame 20 and the liquid crystal panel 11 (array substrate 11B), and a tape end part 34 provided at one end part in the longitudinal direction of the tape body part 31 and arranged outside (on a left side in FIG. 3) than the outer periphery end part of the liquid crystal panel 11. That is, the tape end part 34 is adhered to the frame part 21 but is not adhered to the liquid crystal panel 11. As shown in FIG. 1, the double-sided tape 30 has a linear shape and is arranged in each of four sides of the frame 20. The tape body part 31 has a longitudinal shape that follows one side in the outer periphery end part of the liquid crystal panel 11. The tape end parts 34 of each of the double-sided tapes 30 are arranged respectively at corner parts of the frame 20. On a surface of a tape end part 34 side in the frame part 21, as shown in FIG. 3, a recess part 24 covered by a part 35 of the tape end part 34 is formed. Thus, a surface on a frame 20 side in the part 35 of the tape end part 34 is arranged oppositely at an interval with the frame 20 (a bottom surface 24A of the recess part 24). By the way, the double-sided tape 30 is formed by coating an adhesive on both of front and back surfaces of a flexible tape-like base material.

According to the present Embodiment, an operator can draw out the tape body part 31 from between the frame 20 and the liquid crystal panel 11 by grasping a part 35 of the tape end part 34 with a tool (for example, pincette) and dragging the part 35 along an extension direction of the double-sided tape 30. Thus, a situation where the external force is applied on the liquid crystal panel 11 can be suppressed in comparison with a method where the double-sided tape 30 is peeled by keeping the liquid crystal panel 11 away from the frame 20 from each other. By the way, when the liquid crystal panel 11 and the frame 20 are kept away from each other, an external force in a direction orthogonal to a planar direction of the liquid crystal panel 11 tends to work, and the force tends to work in a direction where the liquid crystal panel 11 is curved. On the other hand, in a method where the tape body part 31 is extracted, since the force tends to be applied in a direction along the planar direction of the liquid crystal panel 11, a situation where the force works in a direction where the liquid crystal panel 11 curves may be effectively suppressed.

Furthermore, a surface on the frame 20 side in the part 35 of the tape end part 34 is arranged oppositely at an interval with the frame 20. Therefore, in comparison with a structure where an entire surface of the tape end part 34 contacts with the frame 20, the tape end part 34 may be readily peeled and grasped. Specifically, by inserting a tool for grasping the tape end part 34 into a space between a bottom surface of the recess part 24 and the tape end part 34, the tape end part 34 may be readily grasped. Furthermore, as shown in FIG. 2, the recess part 24 forms a shape long in a direction orthogonal to a longitudinal direction of the double-sided tape 30. Therefore, compared with the recess part 24, when the tool such as the pincette is inserted, the tape end part 34 is readily grasped.

### Second Embodiment

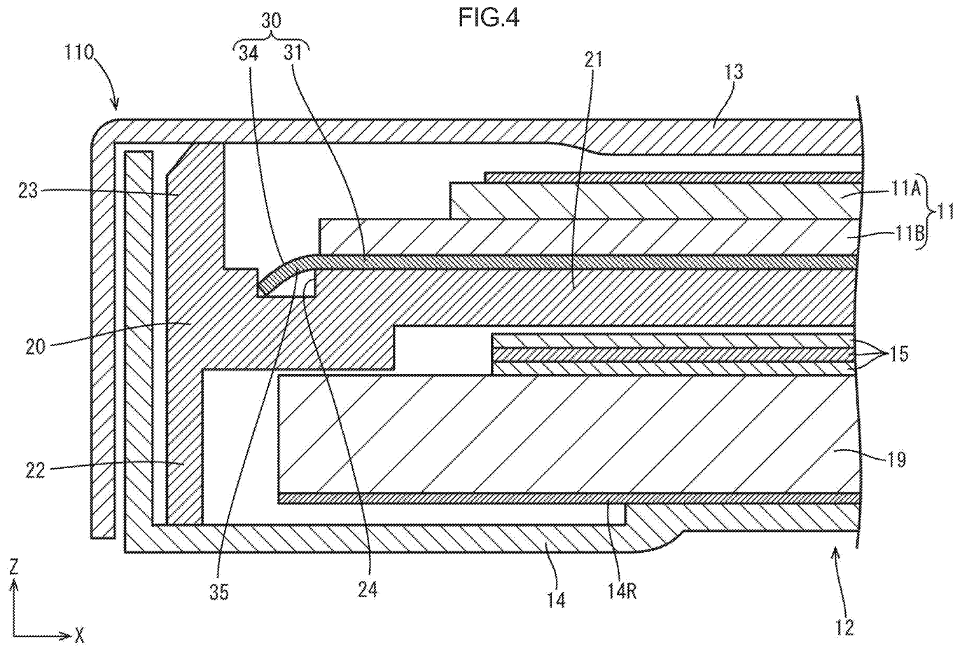

Next, an Embodiment 2 of the present invention will be described with reference to FIG. 4. To the identical part as the above Embodiment, the identical mark is provided to avoid duplicated description. As shown in FIG. 4, in a liquid crystal display device 110 of the present Embodiment, in the recess part 24 of the frame 20, the tape end part 34 is housed. A surface on the frame 20 side in the part 35 of the tape end part 34 is arranged oppositely at an interval with the bottom surface (frame 20) of the recess part 24. Thus, when a tool is inserted in the recess part 24, the part 35 of the tape end part 34 may be readily grasped.

### Third Embodiment

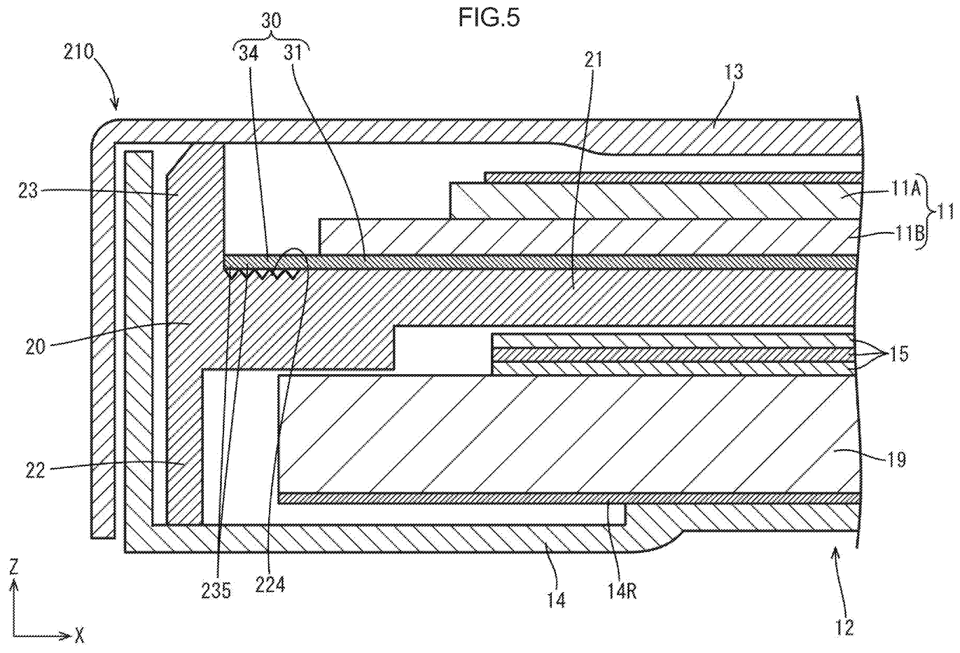

Next, an Embodiment 3 of the present invention will be described with reference to FIG. 5. To the identical part as the above Embodiment, the identical mark is provided to avoid duplicated description. As shown in FIG. 5, in a liquid crystal display device 210 of the present Embodiment, the tape end part 34 is adhered to the frame 20 (frame part 21), and a contact surface with the tape end part 34 in the frame 20 is formed into a grain surface 224 (surface having fine irregularity). Thus, a surface on the frame 20 side in the part 235 of the tape end part 34 is arranged oppositely at an interval with the frame 20. By forming a contact surface with the tape end part 34 into the grain surface 224, a contact area between the tape end part 34 and the frame 20 may be made smaller. Therefore, the tape end part 34 may be readily peeled from the frame 20, and the tape end part 34 is made to be readily grasped.

### Fourth Embodiment

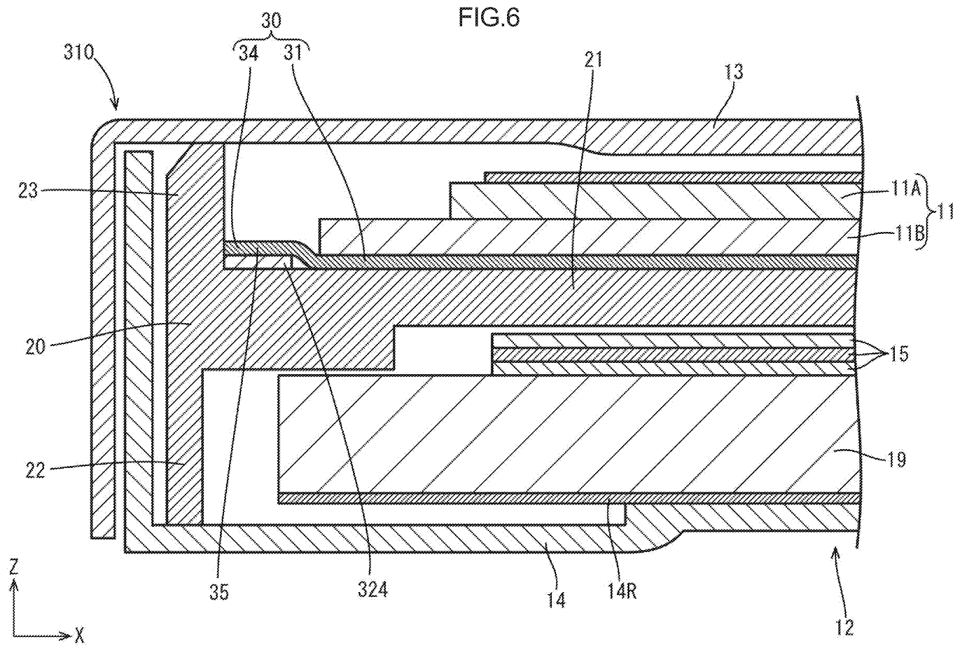

Next, an Embodiment 4 of the present invention will be described with reference to FIG. 6. To the identical part as the above Embodiment, the identical mark is provided to avoid duplicated description. As shown in FIG. 6, in a liquid crystal display device 310 of the present Embodiment, the tape end part 34 is adhered to the frame 20 via an auxiliary double-sided tape 324 having adhesive force weaker than the adhesive force of the tape end part 34. A surface on the frame 20 side in the part 35 of the tape end part 34 is arranged oppositely at an interval with the frame 20. By comparing with a structure where the tape end part 34 is directly adhered to the frame 20, by intervening the auxiliary double-sided tape 324, the tape end part 34 may be readily peeled from the frame part 20, and the tape end part 34 is made to be readily grasped.

### Fifth Embodiment

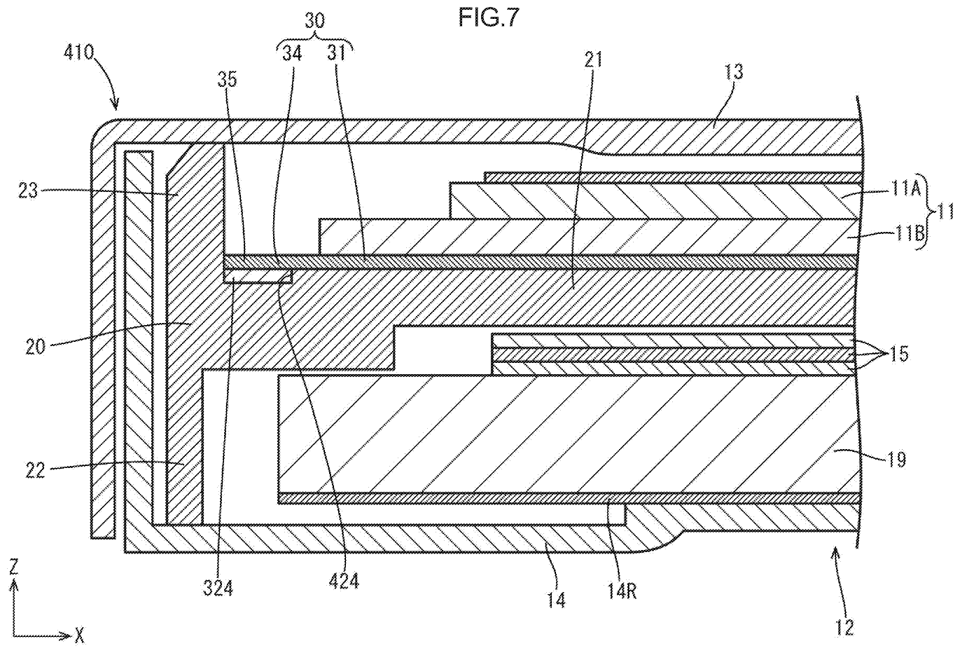

Next, an Embodiment 5 of the present invention will be described with reference to FIG. 7. To the identical part as the above Embodiment, the identical mark is provided to avoid duplicated description. As shown in FIG. 7, in a liquid crystal display device 410 of the present Embodiment, the auxiliary double-sided tape 324 is engaged with a recess part 424 of the frame part 21. That is, a surface on the frame 20 side in the part 35 of the tape end part 34 is arranged oppositely at an interval with the frame 20. By comparing with a structure where the tape end part 34 is directly adhered to the frame 20, by intervening the auxiliary double-sided tape 324, the tape end part 34 may be readily peeled from the frame part 20, and the tape end part 34 is made to be readily grasped.

### Sixth Embodiment

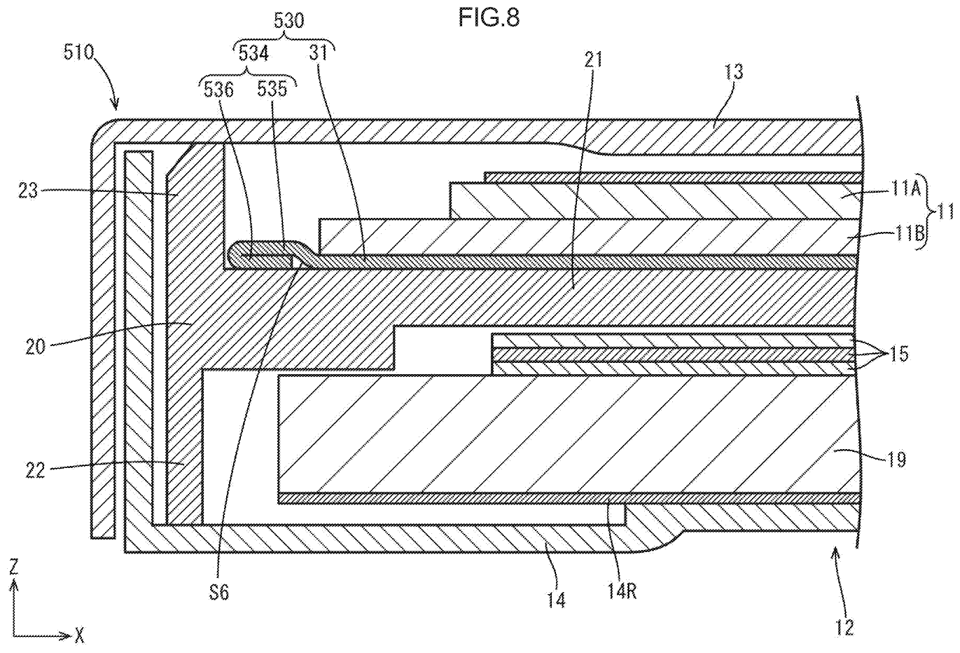

Next, an Embodiment 6 of the present invention will be described with reference to FIG. 8. To the identical part as the above Embodiment, the identical mark is provided to avoid duplicated description. As shown in FIG. 8, in a liquid crystal display device 510 of the present Embodiment, a tape end part 534 of a double-sided tape 530 includes a base end part 535 linked to one end part in the longitudinal direction of the tape body part 31 and a tip part 536 overlapped with the base end part 536. The tip part 536 is arranged in the form of covering the base end part 535 from a back side and is interposed between the base end part 535 and the frame 20. That is, the base end part 535 (at least a part of a tape end part) is arranged oppositely at an interval with the frame 20. By interposing the tip part 536 between the base end part 535 and a holding member, between the base end part 535 and the frame 20, a space S6 corresponding to a thickness of the tip part 536 may be provided and by inserting a tool for grasping the tape end part 534 in the space S6, the base end part 535 can be readily grasped.

### Seventh Embodiment

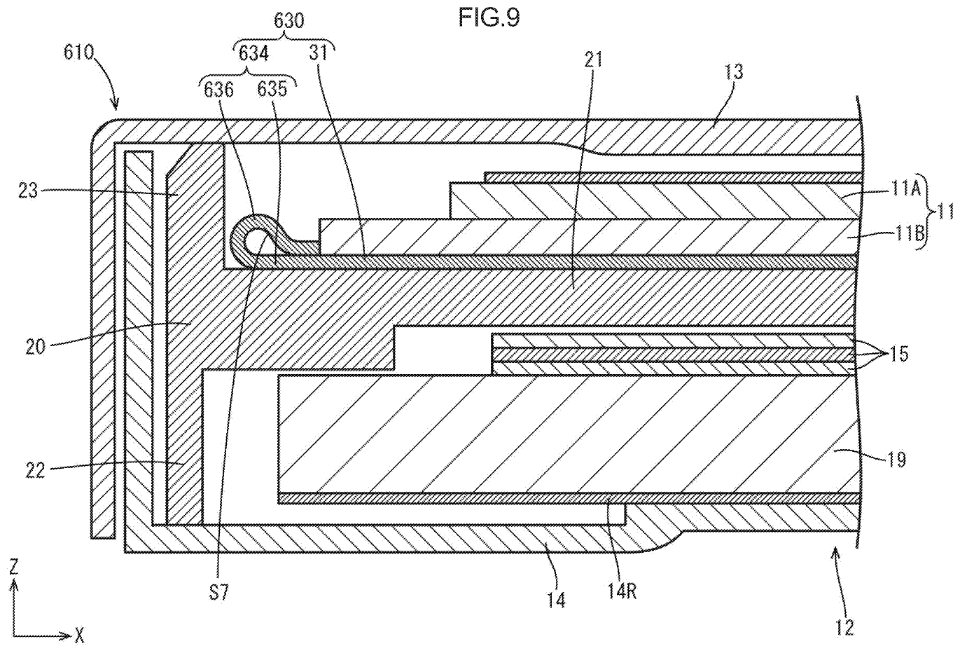

Next, an Embodiment 7 of the present invention will be described with reference to FIG. 9. To the identical part as the above Embodiment, the identical mark is provided to avoid duplicated description. As shown in FIG. 9, in a liquid crystal display device 610 of the present embodiment, a tape end part 634 of a double-sided tape 630 includes a base end part 635 linked to one end part in the longitudinal direction of the tape body part 31 and a tip part 636 overlapped with the base end part 635. The tip part 636 is arranged in the form of covering the base end part 635 from a front side, and the tip part 636 (at least apart of the tape end part) is arranged oppositely at a space S7 with the base end part 635. Thus, by inserting a tool for grasping the tape end part 634 into the space S7 between a part of the tip part 636 and the base end part 635, the tip part 636 may be readily grasped.

### Other Embodiment

The present invention is not limited to the Embodiments described above and explained with reference to the drawings, and, for example, the following Embodiments are also contained in the technical range of the present invention.

(1) Although a structure in which an LED substrate 18 is arranged to each of a pair of peripheral end parts along a longitudinal direction in the light guide plate 19 is shown in the above Embodiments, the present invention is not limited thereto.
(2) In the above Embodiments, an adhesive force of the tape end part 34 of the double-sided tape 30 may be set weaker than the adhesive force of the tape body part 31, and the tape end part 34 may be made to be readily peeled from the frame 20 thereby.
(3) Although in each of the Embodiments described above, a liquid crystal display device that uses a liquid crystal panel as the display panel was illustrated, also in the display device that uses other kind of display panel, the present technology may be applied. The structures (structures for easily performing the grasping and peeling of the tape end part) according to the tape end part illustrated in each of the Embodiments may be appropriately combined in the possible range.

### EXPLANATION OF SYMBOLS

11: Liquid crystal panel (display panel),
20: Frame (holding member),
30: Double-sided tape,
31: Tape body part,
34, 534, 634: Tape end part,
35, 235: a part of the tape end part,
10, 110, 210, 310, 410, 510, 610: Liquid crystal display device (display device),
24, 424: Recess part,
224: Grain surface
324: Auxiliary double-sided tape,
535, 635: Base end part,
536, 636: Tip part,
S7: Space

1. A display device comprising:
a display panel for displaying an image;
a holding member for holding the display panel; and
a double-sided tape for fixing the display panel relative to the holding member, which has a longitudinal tape body part adhered to both the holding member and the display panel, and a tape end part provided to one end part in the longitudinal direction of the tape body part and arranged more outside than an outer periphery end part of the display panel,
wherein a surface of at least a section of the tape end part on the holding member side is arranged oppositely at an interval with the holding member.

2. The display device according to claim 1, wherein on a surface of the tape end part side in the holding member, a recess part covered by at least the part of the tape end part is formed.

3. The display device according to claim 1, wherein
the tape end part is attached to the holding member, and
a contact surface of the holding member with the tape end part is a grain surface.

4. The display device according to claim 1, wherein the tape end part is attached to the holding member via an auxiliary double-sided tape having an adhesive force smaller than the adhesive force of the tape end part.

5. The display device according to claim 1, wherein the tape end part includes:
a base end part linked to the one end part in the longitudinal direction of the tape body part; and
a tip part overlapped with the base end part, and
wherein the tip part is interposed between the base end part and the holding member, and
the base end part is the at least a part of the tape end part.

6. The display device according to claim 1, wherein the tape end part includes:
a base end part linked to the one end part in the longitudinal direction of the tape body part; and
a tip part overlapped with the base end part, and, wherein
the tip part is at least a part of the tape end part, and
a part of the tip part is arranged oppositely at an interval with the base end part.
